(19) United States
(12) Patent Application Publication
(10) Pub. No.: US 2012/0317241 A1
(43) Pub. Date: Dec. 13, 2012

(54) Methods and Systems for Performing Comparisons of Received Data and Providing a Follow-On Service Based on the Comparisons

(75) Inventor: Avery Li-Chun Wang, Palo Alto, CA (US)

(73) Assignee: SHAZAM ENTERTAINMENT LTD., London (GB)

(21) Appl. No.: 13/489,487

(22) Filed: Jun. 6, 2012

Related U.S. Application Data
(60) Provisional application No. 61/494,577, filed on Jun. 8, 2011.

(51) Int. Cl. G06F 15/16; G06F 17/30

(52) U.S. Cl. 709/219

(57) ABSTRACT

Methods and systems for performing comparisons of received data and providing a follow-on service based on the comparisons are described. In one example, a performer may utilize a portable device that includes a microphone to record a data stream of content from an ambient environment of a venue, and provide the data stream of content to a server. A user may utilize another portable device that includes a microphone to record a sample of the content from the ambient environment, and may send the sample to the server. The server may perform a comparison of characteristics of the sample with characteristics of the data stream, and can provide a response to the user with metadata. Further, based on the comparison, the server may register a presence of the user's device at the concert. The server may perform social networking functions based on results of content identification functions.

### CROSS-REFERENCE TO RELATED APPLICATION

The present application claims priority to U.S. Provisional Application Ser. No. 61/494,577 filed on Jun. 8, 2011, the entire contents of which are herein incorporated by reference.

### FIELD

The present disclosure relates to identifying content in a data stream or matching content to that of a data stream, and performing functions in response to an identification or match. For example, the present disclosure relates to performing comparisons of received data and providing a follow-on service, such as registering a presence of a device, based on the comparisons. In some examples, the comparisons may be performed in realtime or substantially realtime.

### BACKGROUND

Content identification systems for various data types, such as audio or video, use many different methods. A client device may capture a media sample recording of a media stream (such as radio), and may then request a server to perform a search in a database of media recordings (also known as media tracks) for a match to identify the media stream. For example, the sample recording may be passed to a content identification server module, which can perform content identification of the sample and return a result of the identification to the client device.

A recognition result may be displayed to a user on the client device or used for various follow-on services. For example, based on a recognition result, a server may offer songs that have been identified for purchase to the user of the client device, so that after hearing a song, a user may tag (i.e., identify) and subsequently purchase a copy of the song on the client device. Other services may be provided as well, such as offering information regarding an artist of an audio song, offering touring information of the artist, or sending links to information on the Internet for the artist or the song, for example.

In addition, content identification may be used for other applications as well including broadcast monitoring or content-sensitive advertising, for example.

### SUMMARY

Examples provided in the disclosure may describe, inter alia, systems and methods for performing content identification functions, and for performing social networking functions based on the content identification functions.

Any of the methods described herein may be provided in a form of instructions stored on a non-transitory, computer readable medium, that when executed by a computing device, perform functions of the method. Further embodiments may also include articles of manufacture including a tangible computer-readable media that have computer-readable instructions encoded thereon, and the instructions may comprise instructions to perform functions of the methods described herein.

The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a computer readable storage medium, for example, or a tangible storage medium.

In addition, circuitry may be provided that is wired to perform logical functions in processes or methods described herein.

The foregoing summary is illustrative only and is not intended to be in any way limiting. In addition to the illustrative aspects, embodiments, and features described above, further aspects, embodiments, and features will become apparent by reference to the figures and the following detailed description.

### BRIEF DESCRIPTION OF THE FIGURES

FIG. 1 illustrates one example of a system for identifying content or information about content within a media or data stream.

FIG. 2 illustrates another example content identification method.

FIG. 3 is a block diagram illustrating an example system that may be configured to operate according to an example content identification method to determine a match between a data stream of content and a sample of content.

FIG. 4 shows a flowchart of an example method for identifying content or information about content in a data stream and performing a follow-on service.

FIG. 5 illustrates an example system for establishing a channel with a content recognition engine.

FIG. 6 is an example flow diagram of messages between elements of FIG. 5.

### DETAILED DESCRIPTION

In the following detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

This disclosure may describe, inter alia, methods and systems for performing content identification functions, and for performing social networking functions based on the content identification functions. For example, based on a content identification or a content match, a social network function may be performed including registering a presence at a location (e.g., “check-in”), indicating a preference for/against content/artist/venue, providing a message on a social networking site (e.g., “Twitter®” or Facebook®), etc. As one example application, a user may tag a song at a concert, which includes sending a sample of the song to a content recognition/identification server and receiving a response, and subsequently may register a presence at the concert based on a successful identification of the song.

In another example, considering a concert venue, a performer may utilize a portable device that includes a microphone to record a data stream of content from an ambient environment of the concert venue, and provide the data stream of content to a server. The data stream of content may be a recording of the performer's songs, etc. A user in the crowd of the concert may utilize another portable device that includes a microphone to record a sample of the content from the ambient environment, and may send the sample to the server. The server may perform a realtime comparison of characteristics of the sample of content with characteristics of the data stream of content, and can provide a response to the user that indicates an identity of content in the sample, an identity of the performer, etc. Based on the realtime comparison, the user may send a request to register a presence at the concert. For instance, if the user receives a response from the server indicating a match between the sample of content at the environment, and the data stream of content at the environment, the user may request the server to register a presence of the user at the environment.

In some examples, a first portable device may be used to record media of an ambient environment and may provide the media to a server. A second portable device in the ambient environment may be used to record a sample of media. Alternatively, the first and/or second device may provide feature-extracted signatures or content patterns in place of the media recordings. In this regard, the first portable device may be considered to supply the server with a signature stream, and the second portable device sends samples of media to the server for comparison with the signature stream. The server may be configured to determine if the sample of ambient media from the second portable device matches to the ambient media provided by the first portable device. A match (or substantial match) between a sample of media and a portion of the signature stream may indicate that the two portable devices are in proximity of each other (e.g., located at or near the same ambient environment), and each device may be receiving (e.g., recording) the same ambient media.

Using examples described herein, any venue or ambient environment may be considered a taggable event, in which a user may utilize a device to capture ambient media of the environment and provide the media to a server to be used or added to a database of media accessed during a content identification/recognition process. As an example use, during a lecture a professor may place a smartphone on a table and use a microphone of the smartphone to provide a recording of the lecture in real-time to a server. A student may “check-in” (e.g., register a presence in the classroom) by “tagging” the lecture using a content identification/recognition service. The student's phone could be used to record a sample of the lecture, and send the sample to the server, which may be configured to match the sample to the lecture stream received from the professor's phone. If there is a match, the student's phone may register a presence in the classroom via Facebook®, Twitter®, etc.

### Example Content Identification Systems and Methods

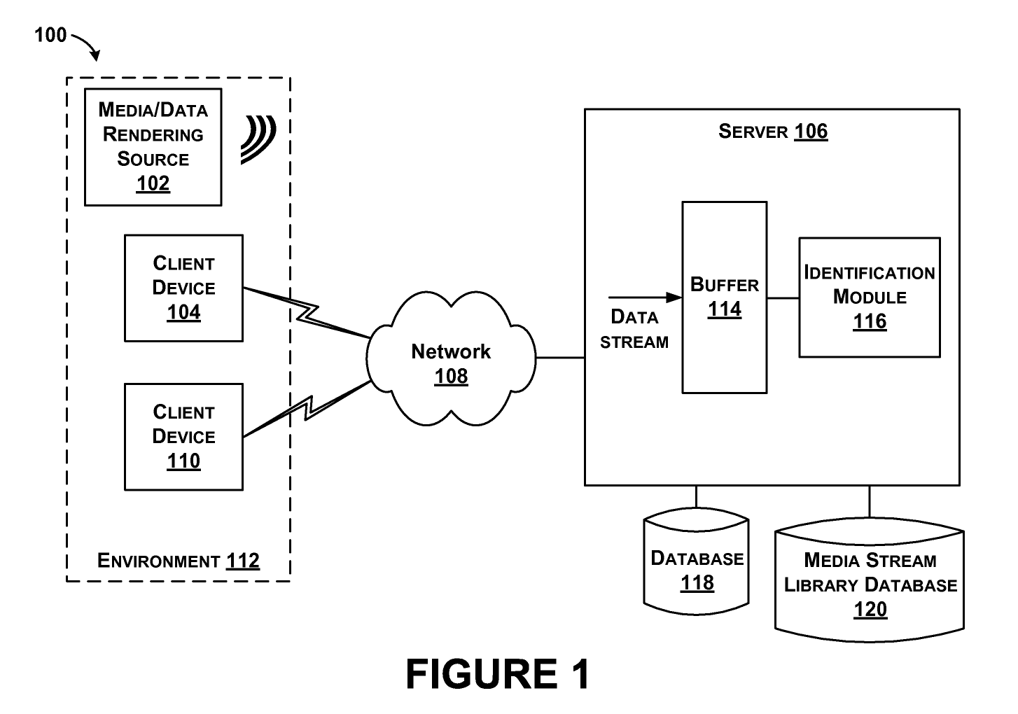

Referring now to the figures, FIG. 1 illustrates one example of a system 100 for identifying content or information about content within a media or data stream. While FIG. 1 illustrates a system that has a given configuration, the components within the system may be arranged in other manners. The system includes a media or data rendering source 102 that renders and presents data content from a data stream in any known manner. The data stream may be stored on the media rendering source 102 or received from external sources, such as an analog or digital broadcast. In one example, the media rendering source 102 may be a radio station or a television content provider that broadcasts media streams (e.g., audio and/or video) and/or other information. The media rendering source 102 may also be any type of device that plays audio or video media in a recorded or live format. In an alternate example, the media rendering source 102 may include a live performance as a source of audio and/or a source of video, for example.

The media rendering source 102 may render or present the media stream through a graphical display, audio speakers, a MIDI musical instrument, an animatronic puppet, etc., or any other kind of presentation provided by the media rendering source 102, for example.

The system 100 further includes a client device 104 that is configured to receive a rendering of the media stream from the media rendering source 102 through an input interface, which may include an antenna, a microphone, video camera, vibration sensor, radio receiver, cable, network interface, etc. As a specific example, the media rendering source 102 may play music, and the client device 104 may include a microphone to receive and record a sample of the music. In another example, the client device 104 may be plugged directly into an output of the media rendering source 102, such as an amplifier, a mixing console, or other output device of the media rendering source.

Within some examples, the client device 104 may not be operationally coupled to the media rendering source 102, other than to receive the rendering of the media stream. In this manner, the client device 104 may not be controlled by the media rendering source 102, and may not be an integral portion of the media rendering source 102. In the example shown in FIG. 1, the client device 104 is a separate entity from the media rendering source 102.

The client device 104 can be implemented as a portion of a small-form factor portable (or mobile) electronic device such as a cell phone, a wireless cell phone, a personal data assistant (PDA), a personal media player device, a wireless web-watch device, a personal headset device, an application specific device, or a hybrid device that include any of the above functions. The client device 104 can also be implemented as a personal computer including both laptop computer and non-laptop computer configurations. The client device 104 can also be a component of a larger device or system as well, and may be in a form of a non-portable device.

The client device 104 may be configured to record the data stream rendered by the media rendering source 102, and to provide the recorded data stream to a server 106. The client device 104 may communicate with the server 106 via a network 108, and connections between the client device 104, the network 108, and the server 106 may be wired or wireless communications (e.g., Wi-Fi, cellular communications, etc.). The client device 104 may be configured to provide a continuous recording/capture of the data stream that is rendered by the media rendering source 102 to the sever 106. In this manner, the server 106 may receive the continuous data stream of content that is rendered by the media rendering source 102 via the client device 104.

The system 100 further includes a second client device 110 that may also be configured to record the data stream rendered by the media rendering source 102. The second client device 110 may be a similar or same type of device as described regarding the client device 104. The second client device 110 may be configured to record a sample of content rendered by the media rendering source 102, to provide the recorded sample of content to the server 106 (e.g., via the network 108), and to request information about the sample of content. The information may include an identity of the content, an identity of a performer of the content, information associated with the identity of the content, etc.

In one example, using the system 100 in FIG. 1, the client device 104 and the second client device 110 may be located or positioned in an environment 112 that includes the media rendering source 102 (or is proximate to the media rendering source 102) such that each of the client device 104 and the second client device 110 may record content rendered by the media rendering source 102. Examples of the environment 112 include a concert venue, a café, a restaurant, a room, a lecture hall, a stadium, a building, or the environment 112 may encompass larger areas such as a downtown area of a city, a city itself, or a portion of a city. Depending on the form of the environment 112, the media rendering source 102 may include a radio broadcast station, a radio, a television, a live performer or band, a speaker, a conversation, ambient environmental sounds, etc.

The system 100 may be configured to enable the client device 104 to provide a continuous (or substantially continuous) recording of the data stream recorded from the media rendering source 102 in the environment 112 to the server 106. The second client device 110 may record a sample of content of the data stream, provide the sample to the server 106, and request information about the sample. The server 106 may compare the sample received from the second client device 110 to the continuous data stream received from the client device 104, and determine whether the sample matches or substantially matches a portion of the continuous data stream. The server 106 may return information to the second client device 110, based on the determination, and may also perform one or more follow-on services, such as providing additional information about the content or registering a presence of the second client device 110 at, in, or near the environment 112.

In one example, the system 100 may be configured to enable a given client device to tag a sample of content, and if the server 106 finds a match based on a data stream received from the environment in which the given client device resides, the server can register a presence of the given client device in the environment.

The server 106 may include one or more components to perform content recognition or realtime identification. For example, the server 106 may include a buffer 114 that receives a media or data stream from the client device 104, and receives a sample from the client device 110. The buffer 114 is coupled to an identification module 116. The buffer 114 may be configured as a rolling buffer so as to receive and store the media stream for a given amount of time, such as to store 10-30 seconds of content at any given time in a first in first out basis, for example. The buffer 114 may store more or less amounts of a media stream as well.

The buffer 114 may be configured into multiple logical buffers, and one portion of the buffer 114 stores the data stream and another portion stores the sample. Alternatively, the buffer 114 may receive and store the data stream, while the identification module 116 may receive the sample from the client device 110.

The identification module 116 may be coupled to the buffer 114 to receive the data stream and/or the sample of media, and may be configured to identify whether the sample matches a portion of the media stream in the buffer 114. In this manner, the identification module 116 may compare the sample with the data stream stored in the buffer 114, and when the buffer 114 stores a short amount of a data stream (e.g., 10-30 seconds), the identification module 116 is configured to determine whether the sample corresponds to a portion of the data stream that is received over the past 30 seconds. In this regard, the identification module 116 performs realtime comparisons to determine whether the sample corresponds to media currently being rendered. The amount of data stream stored in the buffer 114 provides a window of validity for sample correspondences to be identified, thus, in some examples, increasing a probability of a correct match occurring.

Additionally, the identification module 116 may identify a corresponding estimated time position (T_{S}) indicating a time offset of the sample into the data stream. The time position (T_{S}) may also, in some examples, be an elapsed amount of time from a beginning of the data stream or a UTC reference time. The identification module 116 may thus perform a temporal comparison of characteristics of the sample of content with characteristics of the data stream of content to identify a match between the sample and the data stream. For example, a realtime identification may be flagged when the time position (Ts) is substantially similar to a timestamp of the sample of media.

The identification module 116 may be further configured to receive the media sample and the data (media) stream and to perform a content identification on the received media sample or media stream. The content identification identifies the media sample, or identifies information about or related to the media sample, based on a comparison of the media sample with the media stream or with other stored data. The identification module 116 may be used or be incorporated within any example media sample information retrieval services, such as provided by Shazam Entertainment in London, United Kingdom, Gracenote in Emeryville, Calif., or Melodis in San Jose, Calif., for example. These services may operate to receive samples of environmental audio, identify a musical content of the audio sample, and provide the user with information about the music, including the track name, artist, album, artwork, biography, discography, concert tickets, etc.

In this regard, the identification module 116 may include a media search engine and may include or be coupled to a database 118 that indexes reference media streams, for example, to compare the received media sample with the stored information so as to identify information about the received media sample. Once information about the media sample has been identified, track identities or other information may be returned to the second client device 110. The database 118 may also store a data stream as received from the client device 104, for example.

The database 118 may store content patterns that include information to identify pieces of content. The content patterns may include media recordings and each recording may be identified by a unique identifier (e.g., sound_ID). Alternatively, the database 118 may not necessarily store audio or video files for each recording, since the sound_IDs can be used to retrieve audio files from elsewhere. The content patterns may include other information, such as reference signature files including a temporally mapped collection of features describing content of a media recording that has a temporal dimension corresponding to a timeline of the media recording, and each feature may be a description of the content in a vicinity of each mapped timepoint. The content patterns may further include information associated with extracted features of a media file. The database 118 may also include information for each stored content pattern, such as metadata that indicates information about the content pattern like an artist name, a length of song, lyrics of the song, time indices for lines or words of the lyrics, album artwork, or any other identifying or related information to the file.

Although FIG. 1 illustrates the server 106 to include the identification module 116 the identification module 116 may be separate apart from the server 106, for example. In addition, the identification module 116 may be on a remote server connected to the server 106 over the network 108, for example.

Still further, functions of the identification module 116 may be performed by the client device 104 or the second client device 110. For example, the client device 110 may capture a sample of a media stream from the media rendering source 102, and may perform initial processing on the sample so as to create a fingerprint of the media sample. The client device 110 may then send the fingerprint information to the server 106, which may identify information pertaining to the sample based on the fingerprint information alone. In this manner, more computation or identification processing can be performed at the client device 110, rather than at the server 106, for example.

Various content identification techniques are known in the art for performing computational content identifications of media samples and features of media samples using a database of media tracks. The following U.S. Patents and publications describe possible examples for media recognition techniques, and each is entirely incorporated herein by reference, as if fully set forth in this description: Kenyon et al, U.S. Pat. No. 4,843,562, entitled “Broadcast Information Classification System and Method”; Kenyon, U.S. Pat. No. 4,450,531, entitled “Broadcast Signal Recognition System and Method”; Haitsma et al, U.S. Patent Application Publication No. 2008/0263360, entitled “Generating and Matching Hashes of Multimedia Content”; Wang and Culbert, U.S. Pat. No. 7,627,477, entitled “Robust and Invariant Audio Pattern Matching”; Wang, Avery, U.S. Patent Application Publication No. 2007/0143777, entitled “Method and Apparatus for Identification of Broadcast Source”; Wang and Smith, U.S. Pat. No. 6,990,453, entitled “System and Methods for Recognizing Sound and Music Signals in High Noise and Distortion”; and Blum, et al, U.S. Pat. No. 5,918,223, entitled “Method and Article of Manufacture for Content-Based Analysis, Storage, Retrieval, and Segmentation of Audio Information”.

Briefly, a content identification module (within the client device 104, the second client device 110 or the server 106) may be configured to receive a media sample, to correlate the sample with digitized, normalized reference signal segments to obtain correlation function peaks for each resultant correlation segment, and to provide a recognition signal when spacing between the correlation function peaks is within a predetermined limit. A pattern of RMS power values coincident with the correlation function peaks may match within predetermined limits of a pattern of the RMS power values from the digitized reference signal segments, as noted in U.S. Pat. No. 4,450,531, which is entirely incorporated by reference herein, for example. Matching media content can thus be identified. Furthermore, a matching position of the sample in the matching media content may be given by a position of the matching correlation segment, as well as an offset of the correlation peaks, for example.

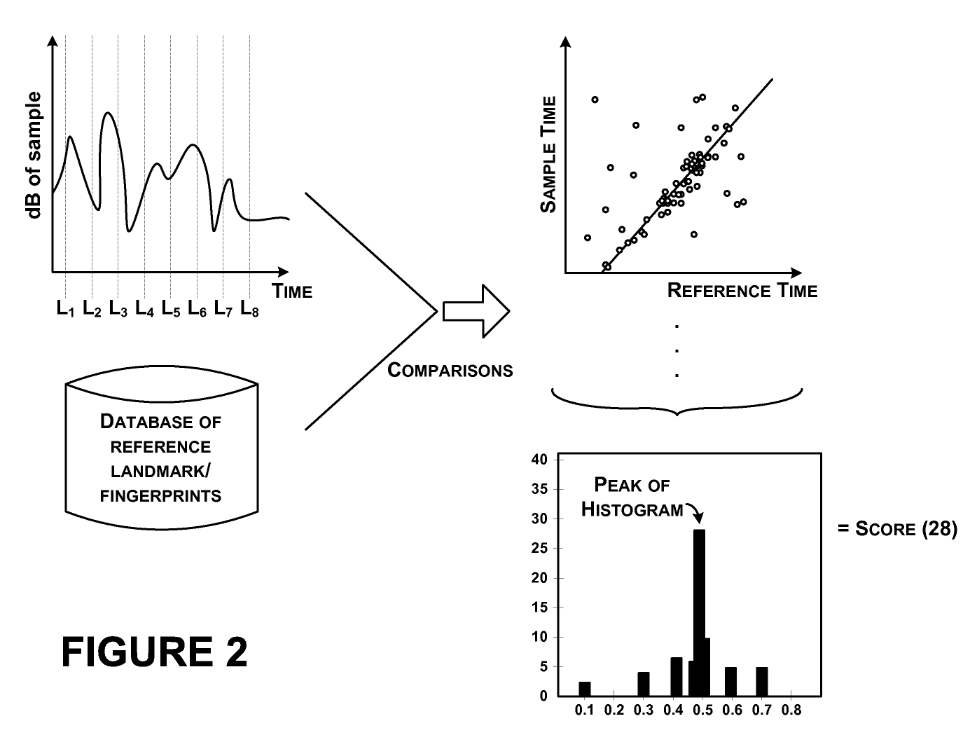

FIG. 2 illustrates another example content identification method. Generally, media content can be identified by identifying or computing characteristics or fingerprints of a media sample and comparing the fingerprints to previously identified fingerprints of reference media files. Particular locations within the sample at which fingerprints are computed may depend on reproducible points in the sample. Such reproducibly computable locations may be referred to as “landmarks.” A location within the sample of the landmarks can be determined by the sample itself, i.e., is dependent upon sample qualities and is reproducible. That is, the same or similar landmarks may be computed for the same signal each time the process is repeated. A landmarking scheme may mark about 5 to about 10 landmarks per second of sound recording; however, landmarking density may depend on an amount of activity within the media recording. One landmarking technique, known as Power Norm, is to calculate an instantaneous power at many time points in the recording and to select local maxima. One way of doing this is to calculate an envelope by rectifying and filtering a waveform directly. Another way is to calculate a Hilbert transform (quadrature) of a signal and use a sum of magnitudes squared of the Hilbert transform and the original signal. Other methods for calculating landmarks may also be used.

FIG. 2 illustrates an example plot of dB (magnitude) of a sample vs. time. The plot illustrates a number of identified landmark positions (L₁ to L₈). Once the landmarks have been determined, a fingerprint is computed at or near each landmark time point in the media. A nearness of a feature to a landmark is defined by the fingerprinting method used. In some cases, a feature is considered near a landmark if the feature clearly corresponds to the landmark and not to a previous or subsequent landmark. In other cases, features correspond to multiple adjacent landmarks. The fingerprint is generally a value or set of values that summarizes a set of features in the media at or near the landmark time point. In one example, each fingerprint is a single numerical value that is a hashed function of multiple features. Other examples of fingerprints include spectral slice fingerprints, multi-slice fingerprints, LPC coefficients, cepstral coefficients, and frequency components of spectrogram peaks.

Fingerprints can be computed by any type of digital signal processing or frequency analysis of the media signal. In one example, to generate spectral slice fingerprints, a frequency analysis is performed in the neighborhood of each landmark timepoint to extract the top several spectral peaks. A fingerprint value may then be the single frequency value of a strongest spectral peak. For more information on calculating characteristics or fingerprints of audio samples, the reader is referred to U.S. Pat. No. 6,990,453, to Wang and Smith, entitled “System and Methods for Recognizing Sound and Music Signals in High Noise and Distortion,” the entire disclosure of which is herein incorporated by reference as if fully set forth in this description.

Thus, referring back to FIG. 1, the client device 104, the second client device 110 or the server 106 may receive a recording (e.g., media/data sample) and compute fingerprints of the recording. In one example, to identify information about the recording, the server 106 can then access the database 118 to match the fingerprints of the recording with fingerprints of known media (e.g., known audio tracks) by generating correspondences between equivalent fingerprints and files in the database 118 to locate a file that has a largest number of linearly related correspondences, or whose relative locations of characteristic fingerprints most closely match the relative locations of the same fingerprints of the recording.

Referring to FIG. 2, a scatter plot of landmarks of the sample and a reference file at which fingerprints match (or substantially match) is illustrated. The sample may be compared to a number of reference files to generate a number of scatter plots. After generating a scatter plot, linear correspondences between the landmark pairs can be identified, and sets can be scored according to the number of pairs that are linearly related. A linear correspondence may occur when a statistically significant number of corresponding sample locations and reference file locations can be described with substantially the same linear equation, within an allowed tolerance, for example. The file of the set with the highest statistically significant score, i.e., with the largest number of linearly related correspondences, is the winning file, and may be deemed the matching media file to the sample. Thus, content of the sample may be identified.

In one example, to generate a score for a file, a histogram of offset values can be generated. The offset values may be differences in landmark time positions between the sample and the reference file where a fingerprint matches. FIG. 2 illustrates an example histogram of offset values. The reference file may be given a score that is equal to the peak of the histogram (e.g., score=28 in FIG. 2). Each reference file can be processed in this manner to generate a score, and the reference file that has a highest score may be determined to be a match to the sample.

As yet another example of a technique to identify content within the media stream, a media sample can be analyzed to identify its content using a localized matching technique. For example, generally, a relationship between two media recordings can be characterized by first matching certain fingerprint objects derived from respective samples. A set of fingerprint objects, each occurring at a particular location, is generated for each media sample. Each location is determined depending upon the content of a respective media sample and each fingerprint object characterizes one or more local features at or near the respective particular location. A relative value is next determined for each pair of matched fingerprint objects. A histogram of the relative values is then generated. If a statistically significant peak is found, the two media samples can be characterized as substantially matching. Additionally, a time stretch ratio, which indicates how much an audio sample has been sped up or slowed down as compared to the original/reference audio track can be determined. For a more detailed explanation of this method, the reader is referred to U.S. Pat. No. 7,627,477, to Wang and Culbert, entitled Robust and Invariant Audio Pattern Matching, the entire disclosure of which is herein incorporated by reference as if fully set forth in this description.

In addition, systems and methods described within the publications incorporated herein may return more than an identity of a media sample. For example, using the method described in U.S. Pat. No. 6,990,453 to Wang and Smith may return, in addition to metadata associated with an identified audio track, a relative time offset (RTO) of a media sample from a beginning of an identified media recording. To determine a relative time offset of the sample, fingerprints of the sample can be compared with fingerprints of the identified recording to which the fingerprints match. Each fingerprint occurs at a given time, so after matching fingerprints to identify the sample, a difference in time between a first fingerprint (of the matching fingerprint in the sample) and a first fingerprint of the stored identified (original) file will be a time offset of the sample, e.g., amount of time into a song. Thus, a relative time offset (e.g., 67 seconds into a song) at which the sample was taken can be determined. Other information may be used as well to determine the RTO. For example, a location of a histogram peak may be considered the time offset from a beginning of the reference recording to the beginning of the sample recording.

Other forms of content identification may also be performed depending on a type of the media sample. For example, a video identification algorithm may be used to identify video content and a position within a video stream (e.g., a movie). An example video identification algorithm is described in Oostveen, J., et al., “Feature Extraction and a Database Strategy for Video Fingerprinting”, Lecture Notes in Computer Science, 2314, (Mar. 11, 2002), 117-128, the entire contents of which are herein incorporated by reference. For example, a position of a video sample into a video can be derived by determining which video frame was identified. To identify the video frame, frames of the media sample can be divided into a grid of rows and columns, and for each block of the grid, a mean of the luminance values of pixels can be computed. A spatial filter can be applied to the computed mean luminance values to derive fingerprint bits for each block of the grid. The fingerprint bits can be used to uniquely identify the frame, and can be compared or matched to fingerprint bits of a database that includes known media. The extracted fingerprint bits from a frame may be referred to as sub-fingerprints, and a fingerprint block is a fixed number of sub-fingerprints from consecutive frames. Using the sub-fingerprints and fingerprint blocks, identification of video samples can be performed. Based on which frame the media sample included, a position into the video (e.g., time offset) can be determined

Furthermore, other forms of content identification may also be performed, such as using watermarking methods. A watermarking method can be used by the identification module 116 to determine the time offset such that the media stream may have embedded watermarks at intervals, and each watermark may specify a time or position of the watermark either directly, or indirectly via a database lookup, for example.

In some of the foregoing example content identification methods for implementing functions of the identification module 116, a byproduct of the identification process may be a time offset of the media sample within the media stream.

In some examples, the server 106 may further access a media stream library database 120 to select a media stream corresponding to the sampled media that may then be returned to the client device 110 to be rendered by the client device 110. Information in the media stream library database 120, or the media stream library database 120 itself, may be included within the database 118.

A media stream corresponding to the media sample may be manually selected by a user of the client device 110, programmatically by the client device 110, or selected by the server 106 based on an identity of the media sample, for example. The selected media stream may be a different kind of media from the media sample, and may be synchronized to the media being rendered by the media rendering source 102. For example, the media sample may be music, and the selected media stream may be lyrics, a musical score, a guitar tablature, musical accompaniment, a video, animatronic puppet dance, an animation sequence, etc., which can be synchronized to the music. The client device 110 may receive the selected media stream corresponding to the media sample, and may render the selected media stream in synchrony with the media being rendered by the media rendering source 102.

An estimated time position of the media being rendered by the media rendering source 102 can be determined by the identification module 116 and can be used to determine a corresponding position within the selected media stream at which to render the selected media stream. When the client device 110 is triggered to capture a media sample, a timestamp (T₀) is recorded from a reference clock of the client device 110. At any time t, an estimated real-time media stream position Tᵣ(t) is determined from the estimated identified media stream position T_{S} plus elapsed time since the time of the timestamp:

Tᵣ(t)=T_{S}+t−T₀ Equation (1)

Tᵣ(t) is an elapsed amount of time from a beginning of the media stream to a real-time position of the media stream as is currently being rendered. Thus, using T_{S} (i.e., the estimated elapsed amount of time from a beginning of the media stream to a position of the media stream based on the recorded sample), the Tᵣ(t) can be calculated. Tᵣ(t) is then used by the client device 110 to present the selected media stream in synchrony with the media being rendered by the media rendering source 102. For example, the client device 110 may begin rendering the selected media stream at the time position Tᵣ(t) or at a position such that Tᵣ(t) amount of time has elapsed so as to render and present the selected media stream in synchrony with the media being rendered by the media rendering source 102.

In some embodiments, to mitigate or prevent the selected media stream from falling out of synchrony with the media being rendered by the media rendering source 102, the estimated position Tᵣ(t) can be adjusted according to a speed adjustment ratio R. For example, methods described in U.S. Pat. No. 7,627,477, entitled “Robust and invariant audio pattern matching”, the entire contents of which are herein incorporated by reference, can be performed to identify the media sample, the estimated identified media stream position T_{S}, and a speed ratio R. To estimate the speed ratio R, cross-frequency ratios of variant parts of matching fingerprints are calculated, and because frequency is inversely proportional to time, a cross-time ratio is the reciprocal of the cross-frequency ratio. A cross-speed ratio R is the cross-frequency ratio (e.g., the reciprocal of the cross-time ratio).

More specifically, using the methods described above, a relationship between two audio samples can be characterized by generating a time-frequency spectrogram of the samples (e.g., computing a Fourier Transform to generate frequency bins in each frame), and identifying local energy peaks of the spectrogram. Information related to the local energy peaks can be extracted and summarized into a list of fingerprint objects, each of which optionally includes a location field, a variant component, and an invariant component. Certain fingerprint objects derived from the spectrogram of the respective audio samples can then be matched. A relative value is determined for each pair of matched fingerprint objects, which may be, for example, a quotient or difference of logarithm of parametric values of the respective audio samples.

In one example, local pairs of spectral peaks are chosen from the spectrogram of the media sample, and each local pair comprises a fingerprint. Similarly, local pairs of spectral peaks are chosen from the spectrogram of a known media stream, and each local pair comprises a fingerprint. Matching fingerprints between the sample and the known media stream can be determined, and time differences between the spectral peaks for each of the sample and the media stream can be calculated. For instance, a time difference between two peaks of the sample is determined and compared to a time difference between two peaks of the known media stream. A ratio of these two time differences can be compared and a histogram can be generated comprising many of such ratios (e.g., extracted from matching pairs of fingerprints). A peak of the histogram may be determined to be an actual speed ratio (e.g., difference between speed at which the media rendering source 102 is playing the media compared to speed at which media is rendered on reference media file). Thus, an estimate of the speed ratio R can be obtained by finding a peak in the histogram, for example, such that the peak in the histogram characterizes the relationship between the two audio samples as a relative pitch, or, in case of linear stretch, a relative playback speed.

Thus, the global relative value (e.g., speed ratio R) can be calculated from matched fingerprint objects using corresponding variant components from the two audio samples. The variant component may be a frequency value determined from a local feature near the location of each fingerprint object. The speed ratio R could be a ratio of frequencies or delta times, or some other function that results in an estimate of a global parameter used to describe the mapping between the two audio samples. The speed ratio R may be considered an estimate of the relative playback speed, for example.

The speed ratio R can be estimated using other methods as well. For example, multiple samples of the media can be captured, and content identification can be performed on each sample to obtain multiple estimated media stream positions T_{S}(k) at reference clock time T₀(k) for the k-th sample. Then, R could be estimated as:

$${R}_{k} = \frac{{T}_{S} ( k ) - {T}_{S} ( 1 )}{{T}_{0} ( k ) - {T}_{0} ( 1 )} \qquad Equation ( 2 )$$

To represent R as time-varying, the following equation may be used:

$${R}_{k} = \frac{{T}_{S} ( k ) - {T}_{S} ( k - 1 )}{{T}_{0} ( k ) - {T}_{0} ( k - 1 )} \qquad Equation ( 3 )$$

Thus, the speed ratio R can be calculated using the estimated time positions T_{S} over a span of time to determine the speed at which the media is being rendered by the media rendering source 102.

Using the speed ratio R, an estimate of the real-time media stream position can be calculated as:

Tᵣ(t)=T_{S}+R(t−T₀) Equation (4)

The real-time media stream position indicates the position in time of the media sample. For example, if the media sample is from a song that has a length of four minutes, and if Tᵣ(t) is one minute, that indicates that the one minute of the song has elapsed.

In one example, using the methods of synchronizing media files to media being rendered by the media rendering source 102 described herein, the client device 104 may provide media to the client device 110 (either directly, or via the network 108 or the server 106), and the client device 110 may render the received media in synchrony with media being rendered by the media rendering source 102.

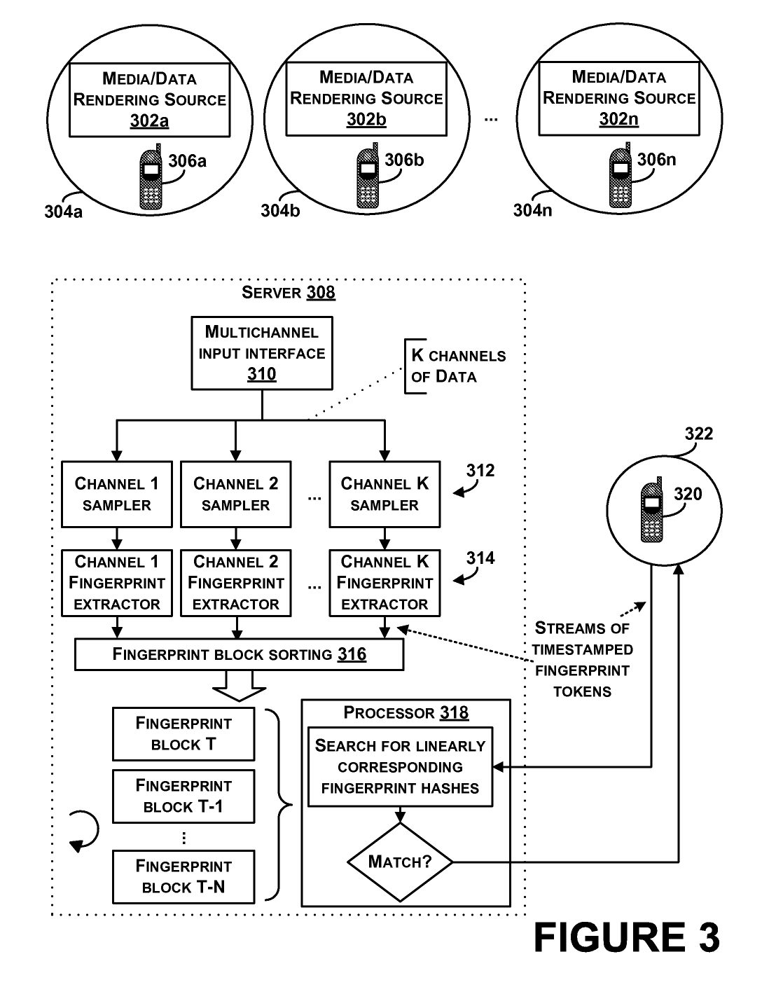

FIG. 3 is a block diagram illustrating an example system that may be configured to operate according to one of the example content identification methods described above to determine a match between a data stream of content and a sample of content. The system includes a number of media/data rendering sources 302a-n that each render media within a respective environment 304a-n. The system further includes client devices 306a-n, each located within one of the respective environments 304a-n. The environments 304a-n may be overlapping, or may be independent environments, for example.

The system further includes a server 308 that is configured to receive a data stream from each of the client devices 306a-n (using a wired or wireless connection). The data stream includes a rendition of content as rendered by the media/data rendering sources 302a-n. In one example, the client devices 306a-n each initiate a connection to the server 308 and stream content that is received from the media rendering sources 302a-n via a microphone to the server 308. In another example, the client devices 306a-n record a data stream of content from the media rendering sources 302a-n and provide the recording to the server 308. The client devices 306a-n may provide recordings of content received from the media rendering source 302a-n in a continuous (or substantially continuous) manner such that the server 308 may combine recordings from a given client device resulting in a data stream of content.

The server 308 includes a multichannel input interface 310 that receives the data streams from the client devices 306a-n, and provides the data streams to channel samplers 312. Each channel sampler 312 includes a channel fingerprint extractor 314 for determining fingerprints of the data streams, using any method described above. The server 308 may be configured to sort and store fingerprints for each data stream for a certain amount of time within a fingerprint block sorter 316. The server 308 can also associate a timestamp with the fingerprints that may or may not reference a real-time or clock so as to log the fingerprints in storage based on when the fingerprints were generated or received. After a predetermined amount of time, the server 308 may overwrite stored fingerprints, for example. A rolling buffer of a predetermined length can be used to store recent fingerprint history.

The server 308 may compute fingerprints by contacting additional recognition engines. The server 308 may determine timestamped fingerprint tokens of the data stream that can be used to compare with received samples. In this regard, the server 308 includes a processor 318 to perform comparison functions.

The system includes another client device 320 positioned within an environment 322. The client device 320 may be configured to record a sample of content received from the ambient environment 322, and to provide the sample of content to the server 308 (using a wired or wireless connection). The client device 308 may provide the sample of content to the server 308 along with an inquiry to determine information about the sample of content. Upon receiving the inquiry from the client device 320, the server 308 may be configured to search for linearly corresponding fingerprints within the stored data stream of fingerprints. In particular, the processor 318 may first select a channel to determine if a data stream fingerprint recorded or received at the server 308 at or near the sample time of the sample received from the client device 320 matches a fingerprint of the sample. If not, the processor 318 selects a next channel and continues searching for a match.

Fingerprints of the data streams and the sample from the client device 320 can be matched by generating correspondence pairs containing sample landmarks and fingerprints computed at the landmarks. Each set of landmark/fingerprint can be scanned for alignment between the data stream and the sample. That is, linear correspondences in the pairs can be identified, and the set can be scored according to a number of pairs that are linearly related. The set with a highest score, i.e., with the largest number of linearly related correspondences, is the winning file and is determined to be a match. If a match is identified, the processor 318 provides a response to the client device 320 that may include identifying information of the sample of content, or additional information of the sample of content.

In one example, the system in FIG. 3 may be configured to enable the client device 320 to tag a sample of content from the ambient environment 322, and if the server 308 finds a match based on a data stream received from one of the client devices 306a-n, the server 308 can perform any number of follow-on services. The server 308 may find a match in an instance in which the client device 320 resides in one of environments 304a-n. In FIG. 3, in one example, the environment 322 may overlap or be included within any of the environments 304a-n, such that the sample of content recorded by the client device 320 and provided to the server 308 is received from one of the media rendering sources 320a-n.

### Example Follow-On Services

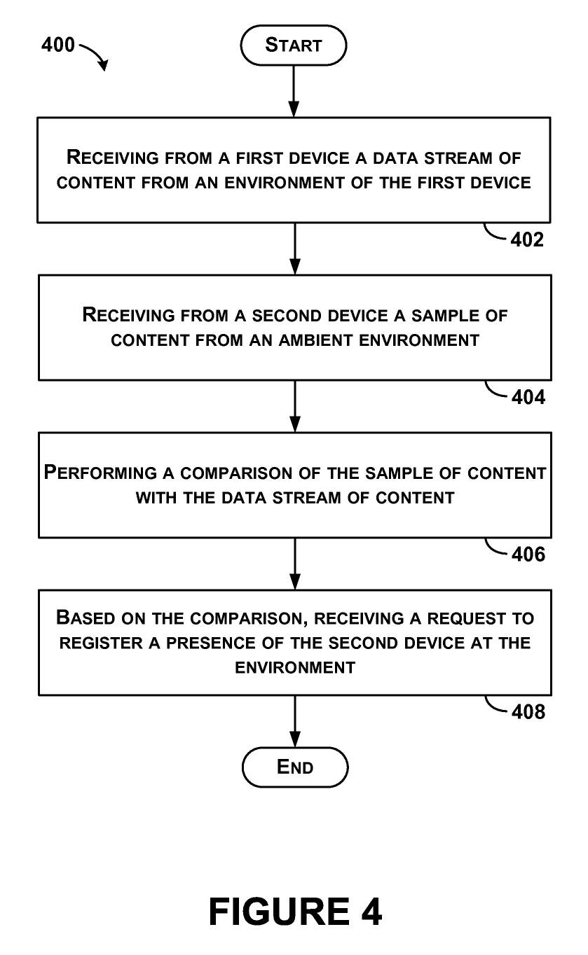

FIG. 4 shows a flowchart of an example method 400 for identifying content or information about content in a data stream and performing a follow-on service. It should be understood that for this and other processes and methods disclosed herein, the flowchart shows functionality and operation of one possible implementation of present embodiments. In this regard, each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. The computer readable medium may include non-transitory computer readable medium, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block in FIG. 4 may represent circuitry that is wired to perform the specific logical functions in the process. Alternative implementations are included within the scope of the example embodiments of the present disclosure in which functions may be executed out of order from that shown or discussed, including substantially concurrent or in reverse order, depending on the functionality involved, as would be understood by those reasonably skilled in the art.

The method 400 includes, at block 402, receiving from a first device a data stream of content from an environment of the first device. For example, the first device may be a portable phone, and may record a data stream of content (e.g., continuous or substantially continuous data content) from an ambient environment of the first device, and may send the data stream to a server. The first device may provide a continuous data stream to the server, such that the first device maintains a connection with the server, or the first device may provide a recording of the data stream as well. As a specific example, a professor may place a portable phone on a table in a lecture hall, record his/her speaking during a lecture, and provide the recording to a server. The data stream of content may include audio, video, or both types of content.

In one example, a plurality of devices may each be present in respective environments and may each provide a data stream of content received from their respective environments to a server. Any number of data streams may be received at a server for further processing according to the method 400.

The method 400 includes, at block 404, receiving from a second device a sample of content from an ambient environment. For example, the second device may be in the environment of the first device and may record a sample of the ambient environment, and send the sample to the server. The server may receive the data stream of content from the first device and the sample of content from the second device at the same times. Continuing with the specific example above, a student may be present in the lecture hall, and may use a portable phone to record a sample of the lecture, and to send the sample to the server.

The method 400 includes, at block 406, performing a comparison of the sample of content with the data stream of content. For example, the server may determine characteristics of each of the sample of content and the data stream of content using any of the methods described above, such as to determine fingerprints of the content. The server may then compare the fingerprints of the sample and of the data stream of content. In this example, characteristics of the content rather than the content itself may be compared. Further, the comparison may not include performing a complete content identification, such as to identify content of the sample of content. Rather, the comparison may include determining whether the sample of content was taken from the same ambient environment as the data stream of content based on matching fingerprints at matching timestamps of the data stream of content and the sample of content.

In one example, the sample of content may include a sample time stamp indicating a sample time of when the sample was recorded (e.g., a reference time or a real-time from a clock). Fingerprints of the sample may be compared with fingerprints of the data stream of content at or near a time corresponding to the timestamp. If characteristics of the fingerprints (e.g., magnitude, frequency, etc.) are within a certain tolerance of each other, the server may identify a match, and may determine that the sample of content was recorded from the same source as the data stream of content.

In other examples, no timestamp may be needed. For instance, in examples in which a small amount of data stream is maintained at any given time (e.g., about 10-30 seconds, 1 minute, a few minutes, etc.), the sample is compared to a small amount of data lowering the possibility of incorrect matches. If a match is found between the sample and the data stream, the match may be determined as valid regardless of where in the data stream the match occurred.

The comparison may be considered a temporal comparison of the sample with the data stream so as to determine whether a match exists. The temporal comparison may include identifying linear correspondences between characteristics of the sample and data stream. In other examples, the comparison may be performed in realtime and may be a realtime comparison of the sample with a portion of a data stream received at or substantially at the same time as the sample. The realtime comparison may compare a sample with a data stream being currently received and buffered (or with portions of the data stream recently received, e.g., the previous 30 seconds or so). Comparison thus occurs in realtime as the data stream is being received, and with content of the data stream currently being rendered by a source.

The method 400 includes, at block 408, based on the comparison, receiving a request to register a presence of the second device at the environment. For example, if the comparison was successful such that the sample of content received from the second device matched (or substantially matched) at least a portion of the data stream of content received from the first device, then the server may make a determination that the first device and the second device are within the same environment and are recording the same ambient content. The server may register a presence of the second device at the environment, or alternatively, as shown at block 408, the server may receive a request (from another server, from the second device, or an entity of a network) to register a presence of the second device at the environment.

Continuing with the example above, the student may receive at his/her portable phone a response from the server indicating information about the sample of content. If the response indicates an identity of the content, an identity of a performer of the content, etc., the student may determine that the content has been recognized/identified, and may utilize an application on the portable phone to request the server to register a presence of the second device at the environment. The application may be executed to cause the portable phone to send a request to register a presence of the second device at the environment to a presence server, which forwards the request to the content identification server, or the content identification server may receive the request and forward the request to a presence server.

In one example, registering a presence at a location may log or indicate a location of the second device, or may indicate a participation in an activity by a user of the second device. The presence may be registered at a social networking website, for example, such as performing a “check-in” through Facebook®. As an example, registering a presence may indicate a location of the second device at a concert, or participation of a user of the second device as a patron at the concert.

In addition to, or rather than, registering a presence, the second device may request other follow-on services to be performed including to indicate a preference for/against content/artist/venue (e.g., to “like” an activity or thing through Facebook®), or to provide a message on a social networking website (e.g., a “Tweet®” on Twitter®, or a “blog” on a Web-log).

In some examples, based on the server receiving multiple data streams, the server may perform multiple comparisons of the sample of content with one or more of the multiple data streams of content. Based on the comparisons, a match may be found between the sample of content and a portion of one of the data streams. The server may thus conclude that the second device resides in the respective environment of the device from which the matching data stream was received.

Using the method 400, the server may further be configured to determine that the first device and the second device are in proximity to one another, or are located or positioned in, at, or near the same environment.

In another example, the method 400 may include fewer steps, such as to perform a register of a presence of the second device at the environment based on the comparison and without receiving the request to register from the second device. In this example, the server may receive the sample of content from the second device, and based on a comparison of characteristics of the sample of content with characteristics of a data stream of content, the server may perform functions to register a presence of the second device at the environment. The sample of content may be provided to the server within a content identification request, for example.

In still another example, the method 400 may include additional steps, such as receiving from a plurality of devices a plurality of data streams of content received from respective environments of the plurality of devices, and performing a comparison of characteristics of the sample of content with characteristics of the plurality of data streams of content. Based on the comparison, it may be determined that the second device resides in one of the respective environments.

The method 400 may include additional functions, such as the server being configured to provide additional information to the second device. In one example, the server may provide an identification of the first device to the second device. In this instance, the server may be configured to inform a user of the second device of a user of the first device that provided the data stream. The server may receive with the data stream of content, information that identifies a user of the first device (or the first device itself that can be used to determine a user of the first device), and can provide this information to the second device.

The method 400 enables any user to establish a channel with a content recognition engine by providing a data stream of content to a recognition server. Users may then provide samples of content to the recognition server, which can be configured to compare the samples to existing database files as well as to received channels of data streams. In some examples, a first device transmits a data stream to the server, and a second device transmits a sample to the server for recognition and comparison to the first device. The data stream and the sample may each be recorded from a given media rendering source.

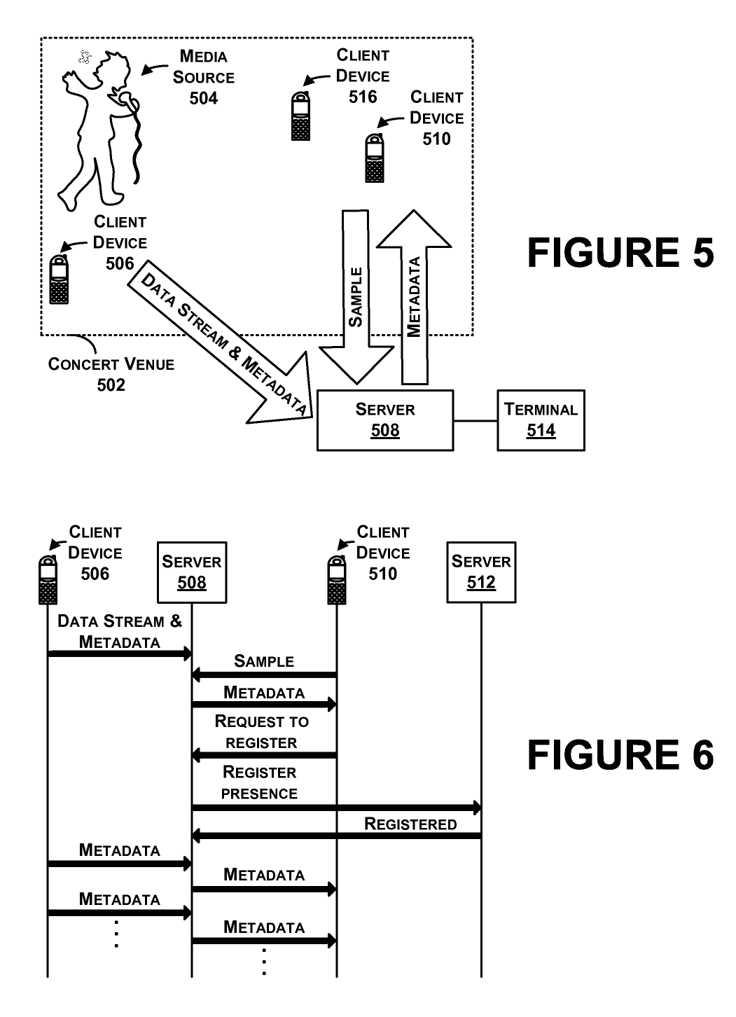

FIG. 5 illustrates an example system for establishing a channel with a content recognition engine, and FIG. 6 is an example flow diagram of messages exchanged between elements of FIG. 5. FIG. 5 illustrates an example environment including a concert venue 502 with a media source 504, which may include a live performer. The performer may have a client device 506 in proximity to the performer and may use the client device to provide a data stream of content of a performance to a server 508. The client device 506 may be a portable phone as shown, or alternatively, may include or be other devices as well. In one example, a client device may be or may include a microphone used by the performer during the performance. Other examples are possible as well.

Within the concert venue 502 a number of guests may be present. One user may have a client device 510 and may record a sample of the performance that can then be provided to the server 508. Upon receipt of the sample, the server 508 may determine if the sample matches any portion of any received data streams. If a match is found, the server 508 may provide a response to the client device 510 that includes metadata.

Subsequently, the client device 510 may send to the server 508 a request to register a presence of the client device 510 at the concert venue 502. The server 508 may then perform functions to register a presence of the client device 510 at the concert venue 502, such as to send a presence message to a presence server 512, for example.

In an alternate example, the server 508 may perform functions to register a presence of the client device 510 at the concert venue 502 after finding a match to the sample without first receiving a request to do so by the client device 510. In this example, the client device 510 may send a sample to the server 508, and if a match is found to the data stream, a presence of the client device 510 at the concert venue 502 is registered.

Members of the audience can utilize a client device to perform functions including tagging the media, registering a presence at the event, receiving a performer's metadata to “Find Out More” about the performer, “Like” or “Tweet” about the concert venue, etc., all based on whether the sample of content matches a portion of the data stream.

Metadata that is provided to the client device 510 may include any type of information, such as an identity of content of the sample, an identity of the performer, URL information, artwork, images, links to purchase content, links to exclusive content, proprietary information received from a user of the client device 506 (e.g., a playlist of the performer at the concert, lyrics), etc.

In another example, metadata that is provided to the client device 510 may include a file, such as a slide show, a presentation, a PDF file, a spreadsheet, web page, HTML5 document, etc., which may include various sequential multimedia that correspond to different parts of a performance or lecture. During the performance, the performer may provide instructions to the server 508 indicating how to proceed or progress through information of the file. For example, if the file includes a slide show, the client device 506 or an auxiliary terminal 514 may be used to send instructions to the server 508 indicating a transition to a next slide. The performer may tap a button on the client device 506 or make a left or right swiping gesture (using a touchpad or touchscreen) to send instructions to the server 508 to progress through the slide show, as shown in FIG. 6 (e.g., sending additional metadata to the server 508). The server 508 may forward the instructions to the client 510 so that the client device 510 can update a display of the slide show accordingly.

In one example, the server 508 may receive the instructions from the client device 506 and then instruct the client device 510 to display information of the client device 506. The server 508 may provide metadata received from the client device 506, as well as instructions for progressing through the metadata, to devices (e.g., all devices) that are “checked into” the concert venue 502 (e.g., that have registered a presence at the concert venue 502). In a further example, the metadata may include annotations indicating when/how to progress through the metadata during the performance, and the server 508 may receive the annotated metadata and may provide the annotated metadata to the client device 510. Thus, metadata provided to devices checked-into the concert venue 502 may be provided or triggered by a user or performer in realtime. Data may be pushed to all checked-in devices, and can be dynamically updated.

As another example, metadata provided by the client device 506 may include an RSS feed, HTML5 page, (or other interactive metadata), in which the client device 510 may receive updates of metadata that the performer/lecturer/band has provided.

In other examples, the performer may update the response metadata dynamically by various means. In one instance, the performer may perform an update by choosing an item from a menu comprising a prepared set list of metadata for possible songs to be played next. The menu could be provided on the client device 506 or on the auxiliary terminal 514, e.g., a laptop. The menu selection could be chosen by the performer or by an assistant operating the auxiliary terminal. The metadata could also be entered by the performer or an assistant in realtime into a database to annotate the current performance in order to support an unplanned encore or whimsical performance.

As described, data may be pushed to all checked-in devices, and can be dynamically updated. Based on being a checked-in device, the server 508 may provide additional options for the device to further register to receive additional information about the performer. As examples, the server 508 may provide options to register for a mailing list of the performer, to follow the performer on a social networking website (e.g., Twitter®, or subscribe to the performer on Facebook®), or to subscribe to an emailing list or RSS feed. The server 508 may be configured to further register a given checked-in device (without receiving a selection from the device) based on settings of the device.

In further examples, data may be received from a checked-in device or information regarding a user of the checked-in device may be received (not necessarily from the checked-in device). For example, the server 508 may receive certain information from the checked-in device or about a user of the checked-in device. Examples of such information include contact information, images, demographic information, a request to subscribe to a service or mailing list, and a request to register for push notifications. Such information may be stored or cached in a memory or server associated with a user profile, and retrieved and provided to the server 508 responsive to a request by the client device 506 or server 508 or programmatically retrieved and provided. Such information may alternatively be entered in realtime via a user of the checked-in device. In this example, the performer or performer's agent can receive information from or about the user to learn more information about an audience.

Thus, within examples described herein, information can flow in both directions between a checked-in device and a client device 506 or server 508. An exchange of information can occur and can be passive (e.g., provided upon registering a presence), or active (e.g., a user chooses to provide information that may be useful for marketing for user/audience members).

In further examples, methods and systems described herein may be used to determine proximity between two devices, and thus, between two users. In one instance, referring to FIG. 5, a user of the client device 510 and a user of another client device 516 may both be located at the concert venue 502. Each device may send samples of the ambient environment to the server 508, which may perform identifications as discussed above. The server 508 may be configured to determine when multiple devices have provided samples matching the same data stream, and may further be configured to notify the devices of such a determination. In this instance, the server 508 can send messages to the client device 510 and the client device 516 notifying each device of the presence of one another at the concert venue 502. Further, the server 508 has determined a proximity of the devices based on content identifications, and does not need to further access a presence server in order to determine proximity (e.g., such as by determining proximity based on matching registered presences of devices).

In another implementation, proximity between two devices may be determined by comparing samples received from each device. In this example, the server 508 may receive a sample from the client device 510 and another sample from the client device 516, and may directly compare both samples. Based on a match, the server 508 may determine that the client device 510 and the client device 516 are located in proximity to each other (e.g., located in an environment in which the same media is being rendered).

As a further implementation alternative, the server 508 may further receive information from the client device 510 and the client device 516 relating to geographic information of the devices (e.g., GPS data), and use the geographic information as a further way to verify content identifications and proximity of devices. For instance, if the client device 510 sent a sample to the server 508, which performed an identification and subsequently facilitated a register of the presence of the client device 510 at the concert venue 502, the server 508 may receive and record GPS coordinates of the client device 510. Then, for subsequent matches found on the sample data stream, or for subsequent requests to register other devices at the same concert venue 502, the server 508 may compare GPS coordinates of the other devices with the stored GPS coordinate of the client device 510 to further verify that the devices are located in proximity or to further verify the content identification.

While various aspects and embodiments have been disclosed herein, other aspects and embodiments will be apparent to those skilled in the art. The various aspects and embodiments disclosed herein are for purposes of illustration and are not intended to be limiting, with the true scope being indicated by the following claims. Many modifications and variations can be made without departing from its scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims.

Since many modifications, variations, and changes in detail can be made to the described example, it is intended that all matters in the preceding description and shown in the accompanying figures be interpreted as illustrative and not in a limiting sense.

What is claimed is:

1. A method comprising:
receiving from a first device a data stream of content received from an environment of the first device;
receiving from a second device a sample of content from the environment;
performing a comparison of the sample of content with the data stream of content; and
based on the comparison, receiving a request to register a presence of the second device at the environment.

2. The method of claim 1, wherein the first device is located in the environment in which content of the data stream of content is rendered, and wherein receiving from the first device the data stream of content received from the environment of the first device comprises receiving from the first device a recording of the data stream of content from the environment of the first device.

3. The method of claim 2, wherein the first device is a portable device and is located within the environment in which the first device records ambient audio.

4. The method of claim 1, wherein receiving from the second device the sample of content from the environment comprises receiving a recording of the sample of content.

5. The method of claim 1, wherein receiving from the first device the data stream of content comprises receiving an ambient audio data stream of audio received from an ambient environment of the first device, and
wherein receiving from the second device the sample of the content from the environment comprises receiving a sample of ambient audio, and
the method further comprises matching the sample of ambient audio with the ambient audio data stream.

6. The method of claim 1, wherein the data stream of content is an audio data stream, and wherein the sample of content includes a sample of audio content.

7. The method of claim 1, wherein the data stream of content is a video data stream, and wherein the sample of content includes a sample of video content.

8. The method of claim 1, further comprising receiving from the first device a continuous data stream of content received from the environment of the first device.

9. The method of claim 1, further comprising based on the comparison, determining that the second device is in proximity to the first device.

10. The method of claim 1, further comprising based on the comparison, determining that the second device is located in the environment of the first device.

11. The method of claim 1, wherein one of the first device and the second device is a portable device that includes a microphone for recording content.

12. The method of claim 1, further comprising registering the presence of the second device at the environment via a social networking application.

13. The method of claim 1, wherein the first device is a microphone.

14. The method of claim 1, wherein receiving from the first device the data stream of content comprises wirelessly receiving the data stream of content.

15. The method of claim 1, wherein performing the comparison of the sample of content with the data stream of content comprises comparing characteristics of the sample of content at associated timepoints in reference to a sampling time with characteristics of the data stream of content at approximately matching timepoints.

16. The method of claim 1, further comprising sending to the second device information, the information being associated with one of an identity of the content or an identity of a performer of the content.

17. The method of claim 16, further comprising:
receiving from the first device instructions to progress through the information; and
sending to the second device instructions indicating to progress through the information.

18. The method of claim 17, wherein sending to the second device instructions indicating to progress through the information comprises sending instructions to the second device indicating to update a display of the information on the second device.

19. The method of claim 17, wherein the content of the data stream of content is provided by a performance, and the method further comprises during the performance, receiving instructions to progress through the information.

20. The method of claim 1, further comprising:
sending information to devices that have registered a presence at the environment, the information being associated with one of an identity of the content, an identity of a performer of the content, artwork for the content, a presentation for the content, purchasing information for the content, touring information for the performer, synchronization information for an associated media stream for the content, or URL information about the content; and
sending instructions indicating to progress through the information to the devices that have registered a presence at the environment.

21. The method of claim 1, further comprising:
sending to the second device interactive metadata; and
providing instructions to the second device indicating to progress through the interactive metadata.

22. The method of claim 1, wherein the first device is coupled to an output of a media rendering source that renders the data stream.

23. The method of claim 1, further comprising:
continuously receiving the data stream;
storing a predetermined amount of the data stream in a buffer such that a portion of the data stream stored corresponds to recently received content of the data stream;
and wherein performing the comparison of the sample of content with the data stream of content comprises performing a realtime comparison of the sample of content with recently received content of the data stream.

24. The method of claim 1, wherein the data stream is rendered by a media rendering source, and the method further comprises:
storing a predetermined amount of the data stream in a buffer such that a portion of the data stream stored corresponds to content of the data stream substantially currently being rendered by the media rendering source;
and wherein performing the comparison of the sample of content with the data stream of content comprises performing a realtime comparison of the sample of content with content substantially currently being rendered by the media rendering source.

25. The method of claim 1, further comprising storing a predetermined amount of the data stream in a buffer, wherein the predetermined amount is associated with a window of validity for the sample of content.

26. The method of claim 1, further comprising sending information to devices that have registered a presence at the environment, the information being associated with the content of the data stream.

27. The method of claim 1, wherein the comparison of the sample of content with the data stream of content is a first comparison, and the method further comprises:
receiving from a third device a given sample of content from the environment;
performing a second comparison of the given sample of content with the data stream of content; and
based on the first comparison and the second comparison being positive matches to content of the data stream, determining a proximity in location between the second device and the third device.

28. The method of claim 27, wherein determining the proximity in location between the second device and the third device comprises determining that the second device and the third device are both located in the environment of the first device.

29. The method of claim 27, further comprising providing a notification to one or both of the second device and the third device indicating proximity to each other.

30. The method of claim 27, further comprising:
receiving from the second device geographic information indicating a location of the second device; and
based on the geographic information, verifying one or more of the comparison of the sample of content with the data stream of content and the proximity determination between the second device and the third device.

31. The method of claim 1, further comprising receiving information about a user of the second device from the second device.

32. The method of claim 1, further comprising receiving information about a user of the second device from a user profile server.

33. The method of claim 1, further comprising receiving information about a user of the second device, wherein the information about the user of the second device includes one or more of contact information, one or more images, demographic information, a request to subscribe to a service or mailing list, and a request to register for push notifications.

34. The method of claim 1, further comprising receiving information about a user of the second device responsive to a request by the first device.

35. The method of claim 1, further comprising:
receiving from a plurality of devices a plurality of data streams of content received from respective environments of the plurality of devices;
performing comparisons of the sample of content with the plurality of data streams of content; and
based on the comparisons, determining that the second device resides in one of the respective environments.

36. A non-transitory computer readable medium having stored therein instructions executable by a computing device to cause the computing device to perform functions of:
receiving from a first device a data stream of content received from an environment of the first device;
receiving from a second device a sample of content from the environment;
performing a comparison of the sample of content with the data stream of content; and
based on the comparison, receiving a request to register a presence of the second device at the environment.

37. The non-transitory computer readable medium of claim 36, wherein receiving from the first device the data stream of content comprises receiving an ambient audio data stream of audio received from an ambient environment of the first device, and
wherein receiving from the second device the sample of the content from the environment comprises receiving a sample of ambient audio, and
the instructions are further executable to perform functions of matching the sample of ambient audio with the ambient audio data stream.

38. The non-transitory computer readable medium of claim 36, wherein the instructions are further executable to perform functions of:
sending to the second device information, the information being associated with one of an identity of the content or an identity of a performer of the content;
receiving from the first device instructions to progress through the information; and
sending to the second device instructions indicating to progress through the information.

39. A server comprising:
a memory having instructions stored therein; and
one or more processors coupled to the memory and configured to execute the instructions to perform functions of:
receiving from a first device a data stream of content received from an environment of the first device;
receiving from a second device a sample of content from the environment;
performing a comparison of the sample of content with the data stream of content; and
based on the comparison, registering a presence of the second device at the environment.

40. The server of claim 39, wherein receiving from the first device the data stream of content comprises receiving an ambient audio data stream of audio received from an ambient environment of the first device, and
wherein receiving from the second device the sample of the content from the environment comprises receiving a sample of ambient audio, and
the instructions are further executable to perform functions of matching the sample of ambient audio with the ambient audio data stream.

41. The server of claim 39, wherein the instructions are further executable to perform functions of:
sending to the second device information, the information being associated with one of an identity of the content or an identity of a performer of the content;
receiving from the first device instructions to progress through the information; and
sending to the second device instructions indicating to progress through the information.

42. A method comprising:
receiving from a device a request to identify a sample of content taken from an environment of the device; and
based on a comparison of the sample of content with a data stream of content received from the environment, registering a presence of the device at the environment.

43. The method of claim 42, wherein receiving from the device the sample of content from the environment comprises receiving a recording of the sample of content.

44. The method of claim 42, wherein the device is a portable device and is located within the environment in which the device records ambient audio.

45. The method of claim 42, wherein the device is a portable device that includes a microphone for recording content.

46. The method of claim 42, further comprising registering the presence of the device at the environment via a social networking application.

47. The method of claim 42, further comprising:
sending to the device information, the information being associated with one of an identity of the content or an identity of a performer of the content; and
sending to the device instructions indicating to progress through the information, the instructions indicating to update a display of the information on the device.
